(19) United States
(12) Patent Application Publication
(10) Pub. No.: US 2026/0230625 A1
(43) Pub. Date: Aug. 6, 2026

(54) Systems and Methods for Homography Motion Vector Estimation

(71) Applicant: Apple Inc., Cupertino, CA (US)

(72) Inventors: Jian Zhou, Pleasanton, CA (US); Jae Young Park, Los Gatos, CA (US)

(21) Appl. No.: 19/046,275

(22) Filed: Feb. 5, 2025

(51) Int. Cl. H04N 19/139

(52) U.S. Cl. CPC H04N 19/139

(57) ABSTRACT

Embodiments described herein relate to generating a motion vector candidate based on a homography matrix. An electronic device captures a first image frame and a second image frame. The electronic device generates the homography matrix based on a transformation from the first image frame to the second image frame and transforms a first coordinate space of the first image frame to generate a second coordinate space. Moreover, the electronic device generates the motion vector candidate based on the first coordinate space and the second coordinate space.

### BACKGROUND

The present disclosure relates generally to employing a homography matrix to generate one or more motion vectors (e.g., homography candidates).

In video encoding, motion vectors, which correspond to the movement of content from one frame to another, are commonly used to efficiently compress and encode data, such as image and video data. These motion vectors enable a reduction of redundant information by predicting how elements within a scene may change over time. However, motion due to moving objects from one frame to another may result in inaccuracies in motion vector estimation (e.g., due to translation or a change in perspective).

### SUMMARY

Systems and methods described herein may employ a homography matrix to perform motion vector estimation. An electronic device may receive a first image frame (e.g., source frame) associated with a first coordinate space (e.g., x-coordinate, y-coordinate) and a second image frame (e.g., reference frame) associated with a second coordinate space (e.g., u-coordinate, v-coordinate). The first image frame and the second image frame may include the movement (e.g., motion) of content from the first image frame to the second image frame. For example, the movement of the content may include a perspective change, a translation, a rotation, and/or zooming in and out.

The electronic device may include an inertial measurement unit (e.g., motion sensor) to capture the movement of the electronic device. Thus, the electronic device may generate a homography matrix based on the movement captured by the inertial measurement unit and/or image features in the first image frame and the second image frame. The homography matrix may be associated with camera motion and/or content background motion. The electronic device may employ the homography matrix to transform a first set of coordinates in the first coordinate space to a second set of coordinates in the second coordinate space.

Moreover, the electronic device may generate one or more motion vectors (e.g., homography candidates) based on the first set of coordinates and the second set of coordinates. For example, the electronic device may determine a difference between a first coordinate space and a second coordinate space to generate the one or more motions vectors. In some embodiments, the electronic device may employ the one or more motion vectors to encode data (e.g., image data) associated with the first image frame or the second image frame. In other embodiments, the electronic device may employ the one or more motion vectors to perform additional motion vector estimation.

### BRIEF DESCRIPTION OF THE DRAWINGS

Various aspects of this disclosure may be better understood upon reading the following detailed description and upon reference to the drawings in which:

FIG. 1 is a block diagram of an electronic device, according to embodiments of the present disclosure;

FIG. 2 is a front view of a handheld device representing an example of the electronic device of FIG. 1, according to embodiments of the present disclosure;

FIG. 3 is a front view of another handheld device representing another example of the electronic device of FIG. 1, according to embodiments of the present disclosure;

FIG. 4 is a perspective view of a notebook computer representing an example of the electronic device of FIG. 1, according to embodiments of the present disclosure;

FIG. 5 illustrates front and side views of a wearable electronic device representing another example of the electronic device of FIG. 1, according to embodiments of the present disclosure;

FIG. 6 is a block diagram of a portion of the electronic device of FIG. 1, including a video encoding system, according to embodiments of the present disclosure;

FIG. 7 is an example illustration of image content depicting a transformation of one or more elements in the image content on a display of the electronic device of FIG. 1, according to embodiments of the present disclosure; and

FIG. 8 is a flowchart of a method for generating a motion vector candidate based on a matrix, according to embodiments of the present disclosure; and

FIG. 9 is a flowchart of a method for generating an x-component and a y-component of the motion vector candidate, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Embodiments described herein generally relate to employing a homography matrix to generate one or more motion vectors (e.g., homography motion vector candidates). An electronic device may capture a first image frame (e.g., source frame) and a second image frame (e.g., reference frame). The first image frame and the second image frame may include the movement (e.g., motion) of content from the first image frame to the second image frame. Thus, the electronic device may generate a homography matrix (e.g., associated with camera motion and/or content background motion) based on the movement captured by an inertial measurement unit of the electronic device and/or image features in the first image frame and the second image frame.

The electronic device may employ the homography matrix to transform a first set of coordinates in a first coordinate space of the first image frame to a second set of coordinates in a second coordinate space of the second image frame. Moreover, the electronic device may generate one or more motion vectors (e.g., motion vector candidates) based on the first set of coordinates and the second set of coordinates. For example, the electronic device may generate an x-component (e.g., associated with a horizontal direction or a horizontal offset) of a motion vector based on a first coordinate (e.g., x-coordinate) of the first image frame and a first coordinate (e.g., u-coordinate) of the second image frame. For example, the electronic device may subtract the first coordinate of the first image frame from the first coordinate of the second image frame to generate the x-component of the motion vector candidate.

Moreover, the electronic device may generate a y-component (e.g., associated with a vertical direction or offset) of the motion vector candidate based on a second coordinate (e.g., y-coordinate) of the first image frame and a second coordinate (e.g., v-coordinate) of the second image frame. As an example, the electronic device may subtract the second coordinate of the first image frame from the second coordinate of the second image frame to generate the y-component. In some embodiments, the electronic device may employ the one or more motion vectors to encode data (e.g., image data) associated with the first image frame or the second image frame. In other embodiments, the electronic device may employ the one or more motion vectors to perform additional motion vector estimation.

As such, by employing a homography matrix, the electronic device may increase accuracy in generating the one or more motion vectors. For example, the homography matrix may enable the electronic device to accurately account for the motion (e.g., global motion), translation, and/or changes in perspective from one image frame to another image frame of data (e.g., in image data or video data) when generating the one or more motion vectors.

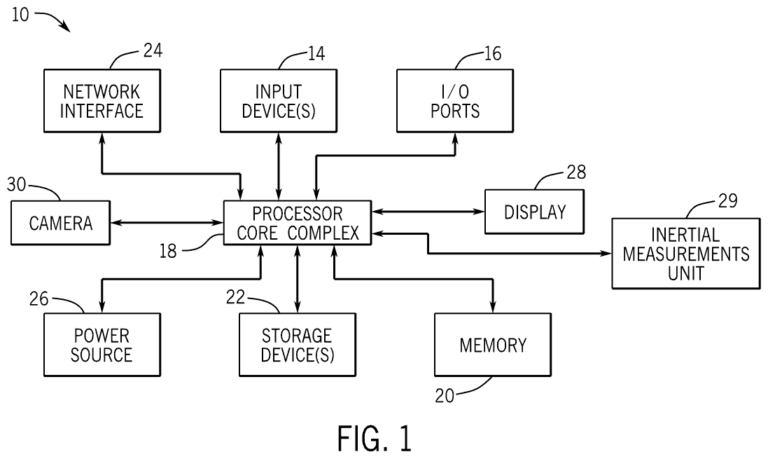

FIG. 1 is a block diagram of an electronic device 10, according to embodiments of the present disclosure. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 includes one or more input devices 14, one or more input/output (I/O) ports 16, a processor core complex 18 having one or more processing circuitry(s) or processing circuitry cores, local memory 20, a main memory storage device 22, a network interface 24, a power source 26 (e.g., power supply), an electronic display 28, an inertial measurement unit 29, and a camera 30. The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component.

In some embodiments, the electronic device 10 may include two or more processor core complexes 18. The embodiments discussed herein may be associated with and/or similarly applicable to embodiments of the electronic device 10 including a single processor core complex 18 and embodiments of the electronic device 10 including two or more processor core complexes 18. For example, one or more of the processor core complexes 18 may include multiple cores including one or more processors, one or more controller, and/or one or more state machine circuits. Each of the two or more processor core complexes 18 may perform some functions or provide at least a portion of control signals and/or instructions discussed herein. In specific embodiments, some of the two or more processor core complexes 18 may be coupled together and may perform certain functions discussed herein individually or in collaboration with each other.

The processor core complex 18 is operably coupled with local memory 20 and the main memory storage device 22. Thus, the processor core complex 18 may execute instructions stored in local memory 20 and/or the main memory storage device 22 to perform operations, such as generating or transmitting image data to display on the electronic display 28 and/or receiving image data generated by the camera 30. As such, the processor core complex 18 may include one or more processors, one or more general purpose microprocessors, one or more application specific integrated circuits (ASICs), one or more field programmable gate arrays (FPGAs), or any combination thereof. In some embodiments, a system on a chip (SoC) may include the processor core complex 18, among other things.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network.

The power source 26 may provide electrical power to one or more components in the electronic device 10, such as the processor core complex 18, the electronic display 28, and/or the camera 30. For example, the power source 26 may include a power supply rail and/or a ground terminal coupled to the one or more components in the electronic device 10, such as the processor core complex 18, the electronic display 28, and/or the camera 30 to provide the electrical power. Thus, the power source 26 may include any suitable source of energy, such as a rechargeable lithium polymer (Li-poly) battery or an alternating current (AC) power converter.

The processor core complex 18 may generate and/or output (e.g., provide) raw data or image data. For example, the display 28 may receive and/or display the raw data or the image data. The I/O ports 16 may enable the electronic device 10 to interface with other electronic devices. For example, when a portable storage device is connected, the I/O port 16 may enable the processor core complex 18 to communicate data with the portable storage device. The input devices 14 may enable user interaction with the electronic device 10, for example, by receiving user inputs via a button, a keyboard, a mouse, a trackpad, or the like. The input device 14 may include touch-sensing components in the electronic display 28. The touch sensing components may receive user inputs by detecting occurrence or position of an object touching the surface of the electronic display 28.

The electronic display 28 may include driver circuitry (e.g., display driver circuitry) and/or a display panel including pixel circuitry with an array of display pixels. Moreover, the driver circuitry may include various circuitry to provide one or more stable positive and/or negative supply voltages, such as the power supply rail and/or the ground terminal. Image data for display on the electronic display 28 may be generated by an image source, such as the processor core complex 18, a graphics processing unit (GPU), or an image sensor. Additionally, in some embodiments, image data may be received from another electronic device 10, for example, via the network interface 24 and/or an I/O port 16. Similarly, the electronic display 28 may display frames based on image data generated by the processor core complex 18, or the electronic display 28 may display frames based on image data received via the network interface 24, an input device, or an I/O port 16.

The inertial measurement unit 29 may include any suitable sensor that may detect motion and/or orientation of the electronic device 10. For example, the inertial measurement unit 29 may include an accelerometer (e.g., to detect changes in velocity of the electronic device 10), a gyroscope (e.g., to detect changes in angular velocity and/or rotation of the electronic device), or any other suitable sensor that may detect motion and/or orientation. In this manner, the electronic device 10 may employ the inertial measurement unit 29 to detect the motion and/or orientation of the electronic device 10. The electronic device 10 may employ the motion and/or orientation of the electronic device 10 to derive a homography matrix for generating motion vectors.

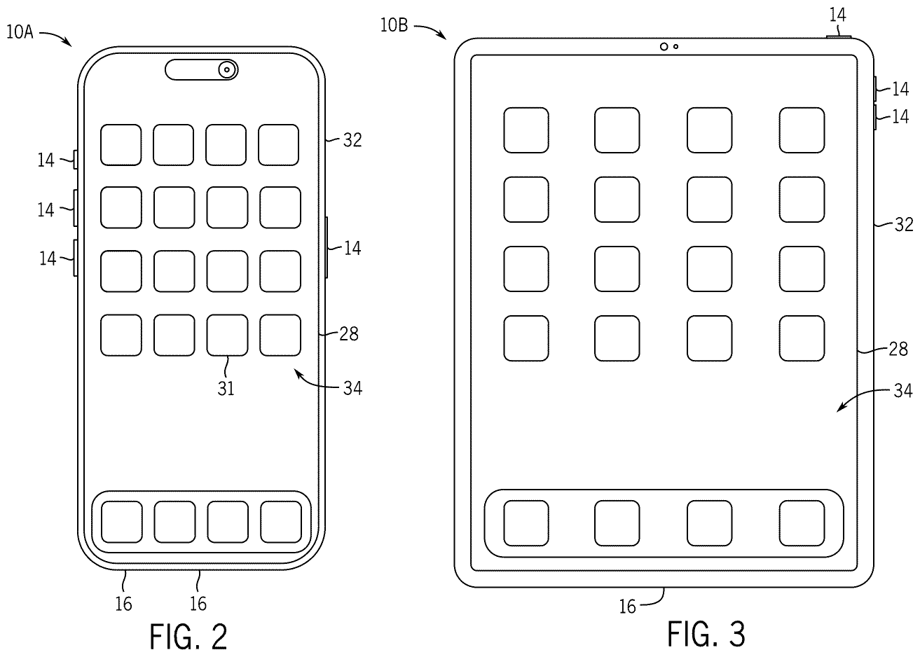

The electronic device 10 may be any suitable electronic device. To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smart phone, such as an IPHONE® model available from Apple Inc.

The handheld device 10A includes an enclosure 32 (e.g., housing). The enclosure 32 may protect interior components from physical damage or shield them from electromagnetic interference, such as by surrounding the electronic display 28. The electronic display 28 may display a graphical user interface (GUI) 34 having an array of icons. When an icon 31 is selected either by an input device 14 or a touch-sensing component of the electronic display 28, an application program may launch.

The input devices 14 may be accessed through openings in the enclosure 32. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

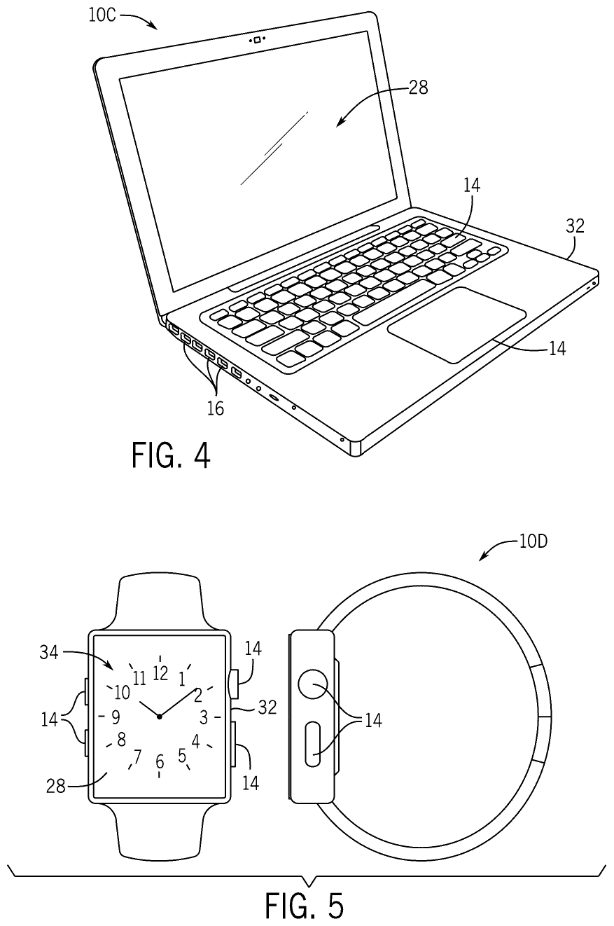

Another example of a suitable electronic device 10, specifically a tablet device 10B, is shown in FIG. 3. The tablet device 10B may be an IPAD® model available from Apple Inc. A further example of a suitable electronic device 10, specifically a computer 10C, is shown in FIG. 4. For illustrative purposes, the computer 10C may be a MACBOOK® or IMAC® model available from Apple Inc. Another example of a suitable electronic device 10, specifically a watch 10D, is shown in FIG. 5. For illustrative purposes, the watch 10D may be an APPLE WATCH® model available from Apple Inc.

As depicted, the tablet device 10B, the computer 10C, and the watch 10D each also includes an electronic display 28, input devices 14, I/O ports 16, and an enclosure 32. The electronic display 28 may display a GUI 34. As shown in FIG. 5, the GUI 34 may show a visualization of a clock. When the visualization is selected either by the input device 14 or a touch-sensing component of the electronic display 28, an application program may launch, such as to transition the GUI 34 to presenting the icons 31 discussed with respect to FIGS. 2 and 3.

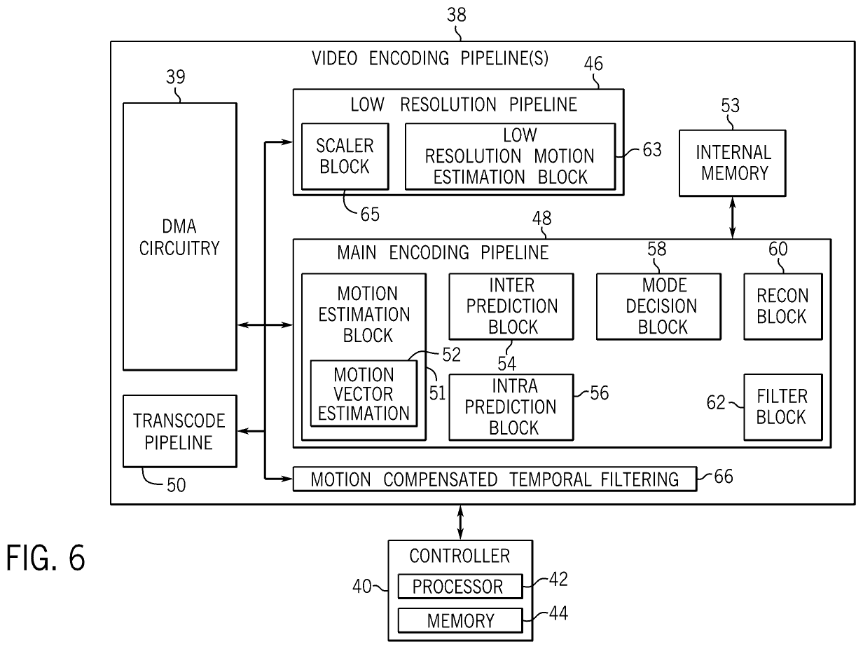

An example of a portion of an electronic device 10, which includes a video encoding system 38, is shown in FIG. 6. The video encoding system 38 may be implemented via circuitry, for example, packaged as a system-on-chip (SoC), such as included in the processor core complex 18 and/or separate image processing circuitry of the electronic device 10. In an embodiment, the image processing circuitry of the electronic device 10 may be a part of the camera 30 or the processor core complex 18. Additionally or alternatively, the video encoding system 38 may be implemented in one or more other processing units, other processing circuitry, or any combination thereof.

The video encoding system 38 may be communicatively coupled to a controller 40. The controller 40 may control the operation of the video encoding system 38. Although depicted as a single controller 40, in other embodiments, one or more separate controllers 40 may be used to control the operation of the video encoding system 38. Additionally, in some embodiments, the controller 40 may be implemented in the video encoding system 38, for example, as a dedicated video encoding controller.

The controller 40 may include a controller processor 42 and controller memory 44. In some embodiments, the controller processor 42 may execute instructions and/or process data stored in the controller memory 44 to control operation of the video encoding system 38. In other embodiments, the controller processor 42 may be hardwired with instructions that control operation of the video encoding system 38 (e.g., as a finite state machine). Additionally, in some embodiments, the controller processor 42 may be included in the processor core complex 18, the image processing circuitry, and/or separate processing circuitry (e.g., in the camera 30 or the electronic display 28), and the controller memory 44 may be included in local memory 21, main memory storage device 22, and/or a separate, tangible, non-transitory computer-readable medium (e.g., in the electronic display 28).

The video encoding system 38 may include direct memory access (DMA) circuitry 39. In some embodiments, the DMA circuitry 39 may communicatively couple the video encoding system 38 to an image sensor, such as external memory that stores source image data, for example, generated by the image sensor or received via the network interface 24 or the I/O ports 16 of FIG. 1.

To facilitate generating encoded image data, the video encoding system 38 may include multiple parallel pipelines. For example, in the depicted embodiment, the video encoding system 38 includes a low-resolution pipeline 46, a main encoding pipeline 48, and a transcode pipeline 50. The main encoding pipeline 48 may encode source image data using prediction techniques (e.g., inter prediction techniques or intra prediction techniques), and the transcode pipeline 50 may subsequently entropy encode syntax elements that indicate encoding parameters (e.g., quantization coefficient, inter prediction mode, and/or intra prediction mode) used to prediction encode the image data.

To facilitate prediction encoding source image data, the main encoding pipeline 48 may perform various functions. To simplify discussion, the functions are divided between various blocks (e.g., circuitry or modules) in the main encoding pipeline 48. In the depicted embodiment, the main encoding pipeline 48 includes a motion estimation block 51, an inter prediction block 54, an intra prediction block 56, a mode decision block 58, a reconstruction block 60, and a filter block 62.

The motion estimation block 51 is communicatively coupled to the DMA circuitry 39. In this manner, the motion estimation block 51 may receive source image data via the DMA circuitry 39, which may include a luma component (e.g., Y) and two chroma components (e.g., Cr and Cb). In some embodiments, the motion estimation block 51 may process one coding unit, including one luma coding block and two chroma coding blocks, at a time. As used herein a “luma coding block” is intended to describe the luma component of a coding unit and a “chroma coding block” is intended to describe a chroma component of a coding unit.

A luma coding block may be the same resolution as the coding unit. On the other hand, the chroma coding blocks may vary in resolution based on chroma sampling format. For example, using a 4:4:4 sampling format, the chroma coding blocks may be the same resolution as the coding unit. However, the chroma coding blocks may be half (e.g., half resolution in the horizontal direction) the resolution of the coding unit when a 4:2:2 sampling format is used and a quarter (e.g., half resolution in the horizontal direction and half resolution in the vertical direction) the resolution of the coding unit when a 4:2:0 sampling format is used.

As described above, a coding unit may include one or more prediction units, which may each be encoded using the same prediction technique, but different prediction modes. Each prediction unit may include one luma prediction block and two chroma prediction blocks. As used herein a “luma prediction block” is intended to describe the luma component of a prediction unit and a “chroma prediction block” is intended to describe a chroma component of the prediction unit. In some embodiments, the luma prediction block may be the same resolution as the prediction unit. On the other hand, similar to the chroma coding blocks, the chroma prediction blocks may vary in resolution based on chroma sampling format.

Based at least in part on the one or more luma prediction blocks, the motion estimation block 51 may determine candidate inter prediction modes that can be used to encode a prediction unit. An inter prediction mode may include a motion vector and a reference index to indicate location (e.g., spatial position and temporal position) of a reference sample relative to a prediction unit. More specifically, the reference index may indicate display order of a reference image frame corresponding with the reference sample relative to a current image frame corresponding with the prediction unit. Additionally, the motion vector may indicate position of the reference sample in the reference image frame relative to position of the prediction unit in the current image frame.

To determine a candidate inter prediction mode, the motion estimation block 51 may search reconstructed luma image data, which may be previously generated by the reconstruction block 60 and stored in internal memory 53 (e.g., reference memory) of the video encoding system 38. For example, the motion estimation block 51 may determine a reference sample for a prediction unit by comparing its luma prediction block to the luma of reconstructed image data. In some embodiments, the motion estimation block 51 may determine how closely a prediction unit and a reference sample match based on a match metric. In some embodiments, the match metric may be the sum of absolute difference (SAD) between a luma prediction block of the prediction unit and luma of the reference sample. Additionally or alternatively, the match metric may be the sum of absolute transformed difference (SATD) between the luma prediction block and luma of the reference sample. When the match metric is above a match threshold, the motion estimation block 51 may determine that the reference sample and the prediction unit do not closely match. On the other hand, when the match metric is below the match threshold, the motion estimation block 51 may determine that the reference sample and the prediction unit are similar.

After a reference sample that sufficiently matches the prediction unit is determined, the motion estimation block 51 may determine location of the reference sample relative to the prediction unit. For example, the motion estimation block 51 may determine a reference index to indicate a reference image frame, which contains the reference sample, relative to a current image frame, which contains the prediction unit. Additionally, the motion estimation block 51 may determine a motion vector to indicate position of the reference sample in the reference frame relative to position of the prediction unit in the current frame. In some embodiments, the motion vector may be expressed as (mvX, mvY), where mvX is horizontal offset and mvY is a vertical offset between the prediction unit and the reference sample. The values of the horizontal and vertical offsets may also be referred to as x-components and y-components, respectively.

In this manner, the motion estimation block 51 may determine candidate inter prediction modes (e.g., reference index and motion vector) for one or more prediction units in the coding unit. The motion estimation block 51 may then input candidate inter prediction modes to the inter prediction block 54. Based at least in part on the candidate inter prediction modes, the inter prediction block 54 may determine luma prediction samples (e.g., predictions of a prediction unit). The motion estimation block 51 may also include motion vector estimation circuitry 52, which may employ a homography matrix to generate one or more motion vectors to generate homography motion vector candidates.

The inter prediction block 54 may determine a luma prediction sample by applying motion compensation to a reference sample indicated by a candidate inter prediction mode. For example, the inter prediction block 54 may apply motion compensation by determining luma of the reference sample at fractional (e.g., quarter or half) pixel positions. The inter prediction block 54 may then input the luma prediction sample and corresponding candidate inter prediction mode to the mode decision block 58 for consideration. In some embodiments, the inter prediction block 54 may sort the candidate inter prediction modes based on associated mode cost and input only a specific number to the mode decision block 58.

The mode decision block 58 may also consider one or more candidate intra or inter predictions modes and corresponding luma prediction samples output by the intra prediction block 56 or the inter prediction block 58. The main encoding pipeline 48 may be capable of implementing multiple (e.g., 13, 17, 25, 29, 35, 38, or 43) different intra prediction modes to generate luma prediction samples based on adjacent pixel image data. Thus, in some embodiments, the intra prediction block 56 may determine a candidate intra prediction mode and corresponding luma prediction sample for a prediction unit based at least in part on luma of reconstructed image data for adjacent (e.g., top, top right, left, or bottom left) pixel values, which may be generated by the reconstruction block 60.

For example, utilizing a vertical prediction mode, the intra prediction block 56 may set each column of a luma prediction sample equal to reconstructed luma of a pixel directly above the column. Additionally, utilizing a DC prediction mode, the intra prediction block 56 may set a luma prediction sample equal to an average of reconstructed luma of pixel values adjacent the prediction sample. The intra prediction block 56 may then input candidate intra prediction modes and corresponding luma prediction samples to the mode decision block 58 for consideration. In some embodiments, the intra prediction block 56 may sort the candidate intra prediction modes based on associated mode cost and input only a specific number to the mode decision block 58.

The mode decision block 58 may determine encoding parameters to be used to encode the source image data (e.g., a coding unit). In some embodiments, the encoding parameters for a coding unit may include prediction technique (e.g., intra prediction techniques or inter prediction techniques) for the coding unit, number of prediction units in the coding unit, size of the prediction units, prediction mode (e.g., intra prediction modes or inter prediction modes) for each of the prediction units, number of transform units in the coding unit, size of the transform units, whether to split the coding unit into smaller coding units, or any combination thereof.

To facilitate determining the encoding parameters, the mode decision block 58 may determine whether the image frame is an I-frame, a P-frame, or a B-frame. In I-frames, source image data is encoded only by referencing other image data used to display the same image frame. Accordingly, when the image frame is an I-frame, the mode decision block 58 may determine that each coding unit in the image frame may be prediction encoded using intra prediction techniques.

On the other hand, in a P-frame or B-frame, source image data may be encoded by referencing image data used to display the same image frame and/or a different image frame. More specifically, in a P-frame, source image data may be encoding by referencing image data associated with a previously coded or transmitted image frame. Additionally, in a B-frame, source image data may be encoded by referencing image data used to code two previous image frames. More specifically, with a B-frame, a prediction sample may be generated based on prediction samples from two previously coded frames; the two frames may be different from one another or the same as one another. Accordingly, when the image frame is a P-frame or a B-frame, the mode decision block 58 may determine that each coding unit in the image frame may be prediction encoded using either intra techniques or inter techniques.

Although using the same prediction technique, the configuration of luma prediction blocks in a coding unit may vary. For example, the coding unit may include a variable number of luma prediction blocks at variable locations within the coding unit, which each uses a different prediction mode. As used herein, a “prediction mode configuration” is intended to describe the number, size, location, and prediction mode of luma prediction blocks in a coding unit. Thus, the mode decision block 58 may determine a candidate inter prediction mode configuration using one or more of the candidate inter prediction modes received from the inter prediction block 54. Additionally, the mode decision block 58 may determine a candidate intra prediction mode configuration using one or more of the candidate intra prediction modes received from the intra prediction block 56.

Since a coding unit may utilize the same prediction technique, the mode decision block 58 may determine prediction technique for the coding unit by comparing rate-distortion metrics (e.g., costs) associated with the candidate prediction mode configurations and/or a skip mode. In some embodiments, the rate-distortion metric may be determined by summing a first product obtained by multiplying an estimated rate that indicates number of bits expected to be used to indicate encoding parameters and a first weighting factor for the estimated rate and a second product obtained by multiplying a distortion metric (e.g., sum of squared difference) resulting from the encoding parameters and a second weighting factor for the distortion metric. The first weighting factor may be a Lagrangian multiplier, and the first weighting factor may depend on a quantization parameter associated with image data being processed.

The distortion metric may indicate amount of distortion in decoded image data expected to be caused by implementing a prediction mode configuration. Accordingly, in some embodiments, the distortion metric may be a sum of squared difference (SSD) between a luma coding block (e.g., source image data) and reconstructed luma image data received from the reconstruction block 60. Additionally or alternatively, the distortion metric may be a sum of absolute transformed difference (SATD) between the luma coding block and reconstructed luma image data received from the reconstruction block 60.

In some embodiments, prediction residuals (e.g., differences between source image data and prediction sample) resulting in a coding unit may be transformed as one or more transform units. As used herein, a “transform unit” is intended to describe a sample within a coding unit that is transformed together. In some embodiments, a coding unit may include a single transform unit. In other embodiments, the coding unit may be divided into multiple transform units, which is each separately transformed.

Additionally, the estimated rate for an intra prediction mode configuration may include expected number of bits used to indicate intra prediction technique (e.g., coding unit overhead), expected number of bits used to indicate intra prediction mode, expected number of bits used to indicate a prediction residual (e.g., source image data-prediction sample), and expected number of bits used to indicate a transform unit split. On the other hand, the estimated rate for an inter prediction mode configuration may include expected number of bits used to indicate inter prediction technique, expected number of bits used to indicate a motion vector (e.g., motion vector difference), and expected number of bits used to indicate a transform unit split. Additionally, the estimated rate of the skip mode may include number of bits expected to be used to indicate the coding unit when prediction encoding is skipped.

The mode decision block 58 may select a prediction mode configuration or skip mode with the lowest associated rate-distortion metric for a coding unit. In this manner, the mode decision block 58 may determine encoding parameters for a coding unit, which may include prediction technique (e.g., intra prediction techniques or inter prediction techniques) for the coding unit, number of prediction units in the coding unit, size of the prediction units, prediction mode (e.g., intra prediction modes or inter prediction modes) for each of the prediction unit, number of transform units in the coding block, size of the transform units, whether to split the coding unit into smaller coding units, or any combination thereof.

To facilitate improving perceived image quality resulting from decoded image data, the main encoding pipeline 48 may mirror decoding of encoded image data. To facilitate, the mode decision block 58 may output the encoding parameters and/or luma prediction samples to the reconstruction block 60. Based on the encoding parameters and reconstructed image data associated with one or more adjacent blocks of image data, the reconstruction block 60 may reconstruct image data.

More specifically, the reconstruction block 60 may generate the luma component of reconstructed image data. In some embodiments, the reconstruction block 60 may generate reconstructed luma image data by subtracting the luma prediction sample from luma of the source image data to determine a luma prediction residual. The reconstruction block 60 may then divide the luma prediction residuals into luma transform blocks as determined by the mode decision block 58, perform a forward transform and quantization on each of the luma transform blocks, and perform an inverse transform and quantization on each of the luma transform blocks to determine a reconstructed luma prediction residual. The reconstruction block 60 may then add the reconstructed luma prediction residual to the luma prediction sample to determine reconstructed luma image data. As described above, the reconstructed luma image data may then be fed back for use in other blocks in the main encoding pipeline 48, for example, via storage in internal memory 53 of the main encoding pipeline 48. Additionally, the reconstructed luma image data may be output to the filter block 62.

The reconstruction block 60 may also generate both chroma components of reconstructed image data. In some embodiments, chroma reconstruction may be dependent on sampling format. For example, when luma and chroma are sampled at the same resolution (e.g., 4:4:4 sampling format), the reconstruction block 60 may utilize the same encoding parameters as used to reconstruct luma image data. In such embodiments, for each chroma component, the reconstruction block 60 may generate a chroma prediction sample by applying the prediction mode configuration determined by the mode decision block 58 to adjacent pixel image data.

The reconstruction block 60 may then subtract the chroma prediction sample from chroma of the source image data to determine a chroma prediction residual. Additionally, the reconstruction block 60 may divide the chroma prediction residual into chroma transform blocks as determined by the mode decision block 58, perform a forward transform and quantization on each of the chroma transform blocks, and perform an inverse transform and quantization on each of the chroma transform blocks to determine a reconstructed chroma prediction residual. The chroma reconstruction block may then add the reconstructed chroma prediction residual to the chroma prediction sample to determine reconstructed chroma image data, which may be input to the filter block 62.

However, in other embodiments, chroma sampling resolution may vary from luma sampling resolution, for example when a 4:2:2 or 4:2:0 sampling format is used. In such embodiments, encoding parameters determined by the mode decision block 58 may be scaled. For example, when the 4:2:2 sampling format is used, size of chroma prediction blocks may be scaled in half horizontally from the size of prediction units determined in the mode decision block 58. Additionally, when the 4:2:0 sampling format is used, size of chroma prediction blocks may be scaled in half vertically and horizontally from the size of prediction units determined in the mode decision block 58. In a similar manner, a motion vector determined by the mode decision block 58 may be scaled for use with chroma prediction blocks.

To improve quality of decoded image data, the filter block 62 may filter the reconstructed image data (e.g., reconstructed chroma image data and/or reconstructed luma image data). In some embodiments, the filter block 62 may perform deblocking and/or sample adaptive offset (SAO) functions. For example, the filter block 62 may perform deblocking on the reconstructed image data to reduce perceivability of blocking artifacts that may be introduced. Additionally, the filter block 62 may perform a sample adaptive offset function by adding offsets to portions of the reconstructed image data.

To enable decoding, encoding parameters used to generate encoded image data may be communicated to a decoding device. In some embodiments, the encoding parameters may include the encoding parameters determined by the mode decision block 58 (e.g., prediction unit configuration and/or transform unit configuration), encoding parameters used by the reconstruction block 60 (e.g., quantization coefficients), and encoding parameters used by the filter block 62. To facilitate communication, the encoding parameters may be expressed as syntax elements. For example, a first syntax element may indicate a prediction mode (e.g., inter prediction mode or intra prediction mode), a second syntax element may indicate a quantization coefficient, a third syntax element may indicate configuration of prediction units, and a fourth syntax element may indicate configuration of transform units.

The transcode pipeline 50 may then convert a bin stream, which is representative of syntax elements generated by the main encoding pipeline 48, to a bit stream with one or more syntax elements represented by a fractional number of bits. In some embodiments, the transcode pipeline 50 may compress bins from the bin stream into bits using arithmetic coding. To facilitate arithmetic coding, the transcode pipeline 50 may determine a context model for a bin, which indicates probability of the bin being a “1” or “0,” based on previous bins. Based on the probability of the bin, the transcode pipeline 50 may divide a range into two sub-ranges. The transcode pipeline 50 may then determine an encoded bit such that it falls within one of two sub-ranges to select the actual value of the bin. In this manner, multiple bins may be represented by a single bit, thereby improving encoding efficiency (e.g., reduction in size of source image data). After entropy encoding, the transcode pipeline 50, may transmit the encoded image data to an output for transmission, storage, and/or display.

Additionally, the encoder circuitry 38 may include the motion compensated temporal filtering circuitry 66, which may perform further motion vector refinement operations and perform temporal filtering operations on the refined motion vectors received from the main encoding pipeline 48 and the low-resolution pipeline 46. The motion compensated temporal filtering circuitry 66 may receive motion vectors from the main encoding pipeline 48, the low-resolution pipeline 46, or both, and may fetch source pixels and reference pixels based on the received motion vectors. Additionally, the motion compensated temporal filter block 66 may perform motion vector refinement based on the received motion vectors and fetched source pixels and reference pixels.

In some embodiments, the motion compensated temporal filter block 66 may include or be coupled to candidate generation circuitry, which may read from the DMA circuitry 39 using motion vector candidates. The candidate generation circuitry may generate (e.g., produce) one or more motion vector candidates to be evaluated for a number of pixel blocks. For example, the one or more candidates may include zero vector candidates, spatial candidates, previous pass candidates (e.g., from a first previous frame and a second previous frame), motion vector candidates, homography estimation candidates, and/or or any other suitable candidates. Embodiments described herein may relate to generating the homography motion estimation candidates (e.g., the motion vector candidates) for use by the motion compensated temporal filter block 66. It should be noted that while the candidate generation circuitry is described as being included in or coupled to the motion compensated temporal filter block 66, the candidate generation circuitry may be included as its own component or as a part of any component described herein in the video encoding system 38.

The motion compensated temporal filter block 66 may use the refined motion vectors to perform temporal filtering operations by calculating a weighted average of the source and reference pixels to determine filtered pixel values for the video image data and transmit the filtered encoded image data to the output for transmission, storage, and/or display. Furthermore, the video encoding system 38 may be communicatively coupled to an output. In this manner, the video encoding system 38 may output encoded (e.g., compressed) image data to such an output, for example, for storage and/or transmission. Thus, in some embodiments, the local memory 20, the main memory storage device 22, the network interface 24, the I/O ports 16, the controller memory 44, or any combination thereof may serve as an output.

As described above, the duration provided for encoding image data may be limited, particularly to enable real-time or near real-time display and/or transmission. To improve operational efficiency (e.g., operating duration and/or power consumption) of the main encoding pipeline 48, the low-resolution pipeline 46 may include a scaler block 65 and a low resolution motion estimation (ME) block 63. The scaler block 65 may receive image data and downscale the image data (e.g., a coding unit) to generate low-resolution image data. For example, the scaler block 65 may downscale a 32×32 coding unit to one-sixteenth resolution to generate an 8×8 downscaled coding unit. In other embodiments, such as embodiments in which the pre-processing circuitry generates image data (e.g., low-resolution image data) from source image data, the low-resolution pipeline 46 may not include the scaler block 65, or the scaler block 65 may not be utilized to downscale image data.

The low-resolution motion estimation block 63 may improve operational efficiency by initializing the motion estimation block 51 with candidate inter prediction modes, which may facilitate reducing searches performed by the motion estimation block 51. Additionally, the low-resolution motion estimation block 63 may improve operational efficiency by generating global motion statistics that may be utilized by the motion estimation block 51 to determine a global motion vector. It should be noted that the electronic device 10 may employ the motion estimation block 51, the low resolution motion estimation block 63, or both when generating the one or more motion vectors.

The electronic device 10 may employ the motion vectors, which are associated with movement of content from one frame to another frame in video data, to encode the video data. By employing a homography matrix, the electronic device 10 may increase accuracy in estimation and/or generation of the motion vectors for encoding the video data. For example, the homography matrix may enable the motion estimation block 51 and/or the low resolution motion estimation block 63 to accurately account for the motion (e.g., global motion), translation, and/or changes in perspective from one frame to another frame in the video data.

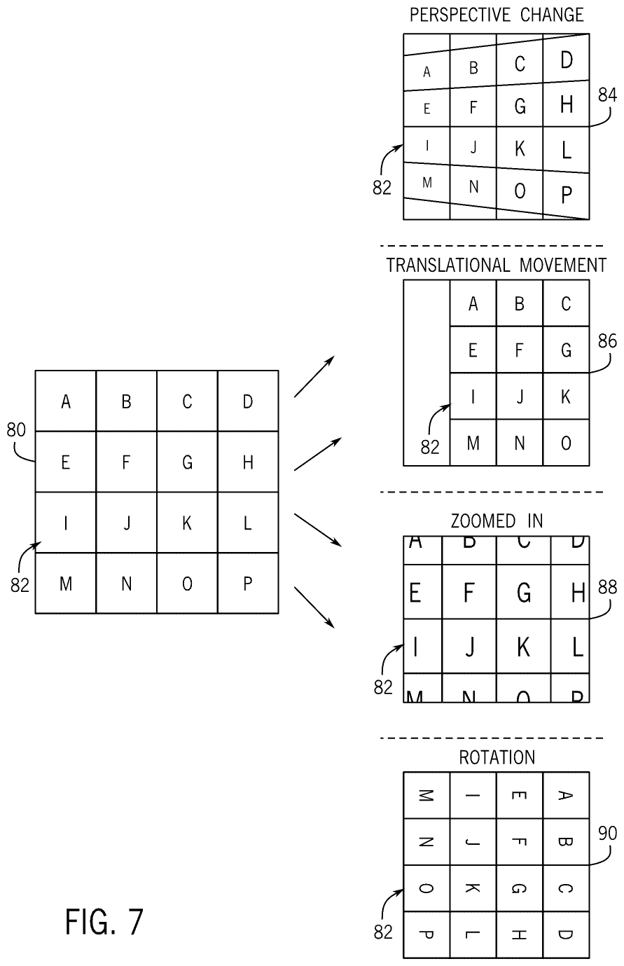

At times, image content captured by the camera 30 may include the movement of the image content. For example, the image content within the image may transition or reposition from a first image frame to a second image frame, which may indicate a change in location, orientation, visual arrangement, and so on between the two frames. FIG. 7 is an example illustration of the image content depicting a transformation of one or more elements in the image content. As illustrated in FIG. 7, image content 80 may include a first image of one or more elements 82. However, as shown in FIG. 7, the one or more elements 82 of the image content 80 may transition and/or reposition in image content 84, image content 86, image content 88, and/or image content 90.

For example, as illustrated in the image content 84, the image content 80 may undergo a perspective change (e.g., keystone effect of the one or more elements 82). That is, the viewpoint of the camera 30 may shift in a manner that distorts shapes and/or proportions of the one or more elements 82 in the image content 80. As shown in FIG. 7, in the image content 80 the one or more elements 82 lines may appear upright or symmetrical. However, in the image content 84, the one or more elements 82 lines may converge or spread out. Thus, the perspective change occurs from the image content 80 to the image content 84. It should be noted that the perspective change in the image content 84 is merely illustrative and the one or more elements 82 may distort or change proportions in any suitable manner based on the viewpoint of the camera 30.

As another example, as illustrated in the image content 86, the image content 80 may undergo a translational movement (e.g., movement of the one or more elements 82 in an upward, downward, right, and/or left direction). As shown in FIG. 7, the one or more elements 82 may shift toward the right in the image content 86. However, it should be noted that the image content 86 is merely illustrative and the one or more elements 82 may shift in any suitable direction in the image content 86.

As yet another example, as illustrated in the image content 88, the image content 80 may undergo scaling (e.g., the one or more elements 82 may be zoomed in or zoomed out). In this manner, the one or more elements 82 may appear closer (e.g., when zoomed in) or further away (e.g., when zoomed out). As shown in FIG. 7, the one or more elements 82 may appear closer. However, it should be noted that the one or more elements 82 appearing closer in the image content 88 is merely illustrative, and the one or more elements 82 may appear even closer if zoomed in more or further away if zoomed out more.

As yet another example, as illustrated in the image content 90, the image content 80 may undergo a rotation (e.g., circular motion of the one or more elements 82 along a central point or axis). In this manner, the one or more elements 82 may change orientation based on the camera 30 turning or rotating. As shown in FIG. 7, the one or more elements 82 in the image content 90 may appear rotated by 90 degrees. It should be noted that the one or more elements 82 may be rotated in any suitable direction by any suitable degrees. Moreover, it should be noted that the movement of the image content 80 shown in the image content 84, the image content 86, the image content 88, and the image content 90 may occur independently, in pairs, or in combination with one another. Indeed, the movement may occur either simultaneously or at different times depending on the motion of the camera 30 of the electronic device 10.

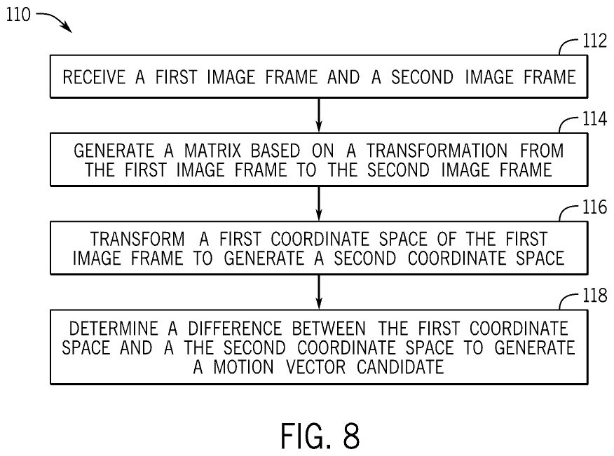

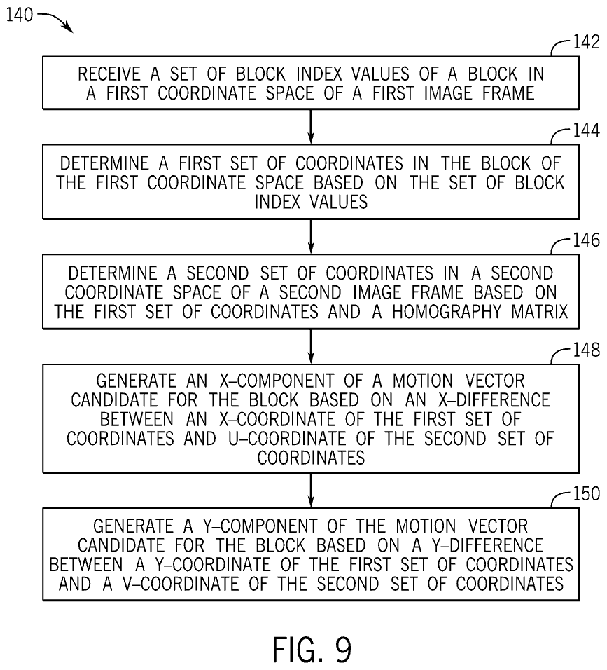

Without motion vector estimation based on the homography matrix, movement of the one or more elements 82 from the image content 80 to the image content 84, the image content 86, the image content 88, and/or the image content 90 may increase difficulty in generating one or more motion vectors and result in inaccuracies of the one or more motion vectors. However, by employing the homography matrix, the electronic device 10 may generate the one or more motion vectors with an increase in accuracy of each of the one or more motion vectors. That is, the electronic device 10 may more accurately determine a horizontal offset (e.g., x-component motion vector) and a vertical offset (e.g., y-component motion vector) of the one or more elements 82 from the image content 80 to either one of or any combination of the image content 84, the image content 86, the image content 88, and the image content 90. Additional details regarding the process for employing the homography matrix to generate the one or more motion vectors will be described in greater detail below with respect to FIGS. 8 and 9.

With the foregoing in mind, FIG. 8 is a flowchart of a method 110 for generating a motion vector candidate (e.g., homography candidate) based on a matrix (e.g., homography matrix). Any suitable device that may control components of the electronic device 10, such as the processor core complex 18, may generate the motion vector candidate. In some embodiments, the method 110 may be implemented by executing instructions stored in a tangible, non-transitory, computer-readable medium, such as the memory 20, using the processor core complex 18. For example, the processor core complex 18 may execute instructions to cause the video encoding system 38 to perform at least some of the steps described herein. Indeed, as an example, the method 110 may be performed by the components of the video encoding system 36 of the electronic device 10, such as the motion estimation block 51 and/or the low resolution motion estimation block 63. As another example, the method 110 may be performed at least in part by one or more software components, such as an operating system of the electronic device 10, one or more software applications of the electronic device 10, and the like. While the method 110 is described using steps in a specific sequence, it should be understood that the present disclosure contemplates that the described steps may be performed in different sequences than the sequence illustrated, and certain described steps may be skipped or not performed altogether.

At block 112, the processor core complex 18 may receive a first image frame and a second image frame (e.g., based on image data captured by the camera 30). At block 114, the processor core complex 18 may generate a matrix, such as a homography matrix, based on a transformation from the first image frame to the second image frame. The matrix may include a 3 by 3 (e.g., 3×3) matrix and may map one or more points of the first image frame to one or more corresponding points of the second image frame. Indeed, the matrix may be associated with how the first image frame is transformed into the second image frame through a perspective change, rotation, translation, and/or scaling (e.g., zooming in, zooming out). The processor core complex 18 may apply the matrix to a block (e.g., 2×2 pixel block, 3×3 pixel block, 4×4 pixel block, and so on) of the first image frame or the second image frame. An example of the matrix is shown below:

$$M = [ \begin{matrix}m 0 & m 1 & m 2 \\ m 3 & m 4 & m 5 \\ m 6 & m 7 & m 8\end{matrix} ] \qquad ( Matrix 1 )$$

In some embodiments, entries (e.g., parameters) m2 and m5 of the matrix may be associated with translation (e.g., two-dimensional translation motion). Moreover, entries m0, m1, m3, and m4 of the matrix may be associated with rotation and/or scaling. Entries m6 and m7 of the matrix may be associated with a perspective change. In addition, in some embodiments, entry m8 of the matrix may be set to a value of one. In this manner, entry m8 may prevent additional application of scaling factors (e.g., global scaling factors) when performing mapping. In other embodiments, the entry m8 may be any value other than one, such as if the first image frame and the second image frame have different resolutions and/or if the matrix is applied to create a mapping across multiple image frames (e.g., by skipping image frames). The matrix may be specified (e.g., defined) based on a full-resolution (e.g., L0) pixel scale level. The entries of the matrix may be associated with different precision values. For example, entries m0, m1, m3, and m4 may be associated with a low pixel search range and a higher precision value (e.g., sign (s) 2.18). Additionally, entries m6 and m7 may be associated with a higher precision value (e.g., s2.28). As another example, entries m2 and m5 may be associated with a lower precision value (e.g., s12.5). The lower precision value may cover the full-resolution pixel scale level within a search range (e.g., [−4096, 4096] with one over thirty-two pixel precision).

In some embodiments, entries (e.g., parameters) m2 and m5 of the matrix may be associated with translation (e.g., two-dimensional translation motion). Moreover, entries m0, m1, m3, and m4 of the matrix may be associated with rotation and/or scaling. Entries m6 and m7 of the matrix may be associated with a perspective change. In addition, in some embodiments, entry m8 of the matrix may be set to a value of one. In this manner, entry m8 may prevent additional application of scaling factors (e.g., global scaling factors) when performing mapping. In other embodiments, the entry m8 may be any value other than one, such as if the first image frame and the second image frame have different resolutions and/or if the matrix is applied to create a mapping across multiple image frames (e.g., by skipping image frames). The matrix may be specified (e.g., defined) based on a full-resolution (e.g., L0) pixel scale level. The entries of the matrix may be associated with different precision values. For example, entries m0, m1, m3, and m4 may be associated with a low pixel search range and a higher precision value (e.g., sign (s) 2.18). Additionally, entries m6 and m7 may be associated with a higher precision value (e.g., s2.28). As another example, entries m2 and m5 may be associated with a lower precision value (e.g., s12.5). The lower precision value may cover the full-resolution pixel scale level within a search range (e.g., [−4096, 4096] with one over thirty-two pixel precision).

At block 116, the processor core complex 18 may transform a first coordinate space (e.g., x, y coordinate space) of the first image frame to generate a second coordinate space (e.g., u, v, coordinate space). As an example, to transform an x-coordinate and a y-coordinate in the first coordinate space to a u-coordinate and a v-coordinate in the second coordinate space, the processor core complex 18 may employ Equation 1 and Equation 2 which are shown below:

$$u = \frac{m 0 * x + m 1 * y + m 2}{m 6 * x + m 7 * y + m 8} \qquad ( Equation 1 )$$

$$v = \frac{m 3 * x + m 4 * y + m 5}{m 6 * x + m 7 * y + m 8} \qquad ( Equation 2 )$$

It should be noted that the numerator of each of Equation 1 and Equation 2 may represent affine transformation components (e.g., to map points, lines, shapes, and so on in one coordinate space to another). Indeed, the terms of the numerator may combine translation, rotation, scaling, and any other suitable effects to apply to the input coordinates (e.g., the x-coordinate and y-coordinate). Moreover, the denominator of each of Equation 1 and Equation 2 may represent the perspective change (e.g., keystone effect) components (e.g., to account for depths and/or distances in the coordinate space).

At block 118, the processor core complex 18 may determine a difference between the first coordinate space and the second coordinate space to generate the motion vector candidate. The difference between the first coordinate space and the second coordinate space may represent a change in position between the first image frame and the second image frame. For example, the processor core complex 18 may employ Equation 3 to generate an x-component of the motion vector candidate, as shown below:

$$M V x = u - x \qquad ( Equation 3 )$$

As shown in Equation 3, the processor core complex 18 may subtract the x-coordinate of the first image frame from the u-coordinate of the second image frame to generate the x-component of the motion vector candidate. As another example, the processor core complex 18 may employ Equation 4 to generate a y-component of the motion vector coordinate, as shown below:

$$M V y = v - y \qquad ( Equation 4 )$$

As shown in Equation 4, the processor core complex 18 may subtract the y-coordinate of the first image frame from the v-coordinate of the second image frame to generate the y-component of the motion vector candidate. The processor core complex 18 may employ the method 110 described herein on a per-block (e.g., per 2×2 pixel block, 3×3 pixel block, 4×4 pixel block, and so on) basis of the first image frame or the second image frame. Further, as an example, the processor core complex 18 may repeat the method 110 any suitable number of times on the per-block basis (e.g., per pixel block) for the first image frame. As such, the method 110 may enable the electronic device 10 to determine movement of each block from the first image frame to the second image frame.

It should be noted that, in some embodiments, the processor core complex 18 may receive one or more inputs and may employ the one or more inputs in generating the one or more motion vectors. For example, the processor core complex 18 may receive and employ one or more constant values (e.g., pre-defined constant values), such as affine bits (e.g., 18 bits), which may be associated with the entries of the matrix, motion vector sub-pixel bits (e.g., pre-defined desired output motion vector precision values), perspective bits (e.g., 28 bits) for the matrix, and/or reciprocal bits (e.g., 22 bits). Further, the processor core complex 18 may calculate and employ a minimum motion vector range (e.g., min MVx, MVy) and a maximum motion vector range (e.g., max MVx, MVy) based on a search for the x-coordinate, a search for the y-coordinate, the motion vector sub-pixel bits, a horizontal offset, a vertical offset, and/or a shift of the bits.

Additionally or alternatively, the one or more inputs may include block index values (e.g., at an input layer), block size bits, current layer bits, and/or division bits. For example, the block index values may be associated with x-coordinates and y-coordinates of a 4×4 pixel block. In some embodiments, the block size bits may vary based on a mode of operation of the electronic device 10. For example, if the electronic device is operating in a first mode of operation (e.g., recursive search mode) the block size bits may be a value of two bits. However, if the electronic device is operating in a second mode of operation (e.g., a green-ghost image artifact mitigation mode) the block size bits may be a higher value (e.g., a value of three bits).

The current layer bits may be associated with a layer level (e.g., scale level). For example, a first layer level (e.g., with full resolution pixels) may be associated with a current bit layer value of zero, a second layer level (e.g., with half resolution pixels) may be associated with a current layer bit value of one, and a third layer level (with quarter resolution pixels) may be associated with a current layer bit value of two. The division bits may be associated with a shift value (e.g., a value between one and seven based on a number of registers of the electronic device 10). Additional details regarding employing the one or more inputs to generate the one or more motion vector candidates will be described below with respect to FIG. 9.

With the foregoing in mind, FIG. 9 is a flowchart of a method 140 for generating an x-component and a y-component of the motion vector candidate. Any suitable device that may control components of the electronic device 10, such as the processor core complex 18, may generate the motion vector candidate. In some embodiments, the method 140 may be implemented by executing instructions stored in a tangible, non-transitory, computer-readable medium, such as the memory 20, using the processor core complex 18. For example, the processor core complex 18 may execute instructions to cause the video encoding system 38 to perform at least some of the steps described herein. Indeed, as an example, the method 140 may be performed by the components of the video encoding system 36 of the electronic device 10, such as the motion estimation block 51 and/or the low resolution motion estimation block 63. As another example, the method 140 may be performed at least in part by one or more software components, such as an operating system of the electronic device 10, one or more software applications of the electronic device 10, and the like. While the method 140 is described using steps in a specific sequence, it should be understood that the present disclosure contemplates that the described steps may be performed in different sequences than the sequence illustrated, and certain described steps may be skipped or not performed altogether.

At block 142, the processor core complex 18 may receive a set of block index values of a block in a first coordinate space of a first image frame. As described herein, the set of block index values may be associated with a block of the first image frame. The set of block index values may enable the processor core complex 18 to identify a location (e.g., placement, position) of the block within the first image frame. At block 144, the processor core complex 18 may determine (e.g., compute, calculate) a first set of coordinates (e.g., x-coordinate, y coordinate) in the block of the first coordinate space based on the set of block index values. As an example, the processor core complex 18 may shift a first block index value (e.g., bx-coordinate) of the set of block index values and a second block index value (e.g., by-coordinate) of the set of block index values by the number of bits. In some embodiments, the processor core complex 18 may determine the number of bits by adding the block size bits to the current layer bits and then subtracting a value of one.

At block 146, the processor core complex 18 may determine a second set of coordinates (e.g., u-coordinate, v-coordinate) in a second coordinate space of a second image frame based on the first set of coordinates and a homography matrix. As described herein, motion from the first image frame to the second image frame may include at least the perspective change (e.g., keystone effect, depth change). Thus, in some embodiments, when determining the second set of coordinates, the processor core complex 18 may also employ the one or more inputs described herein. For example, to determine the second set of coordinates, the processor core complex 18 may employ the affine bits, the motion vector sub-pixel bits, and the number of bits in the numerator of Equation 1 and/or Equation 2.

Moreover, to determine the second set of coordinates, the processor core complex 18 may employ the division bits, the perspective bits, and the reciprocal bits in the denominator of Equation 1 and/or Equation 2. It should be noted that the processor core complex 18 may employ any of the one or more inputs described herein to adjust coefficients of Equation 1 and/or Equation 2. For example, each of the coefficients of Equation 1 and/or Equation 2 may operate distinctly (e.g., perform alternative roles) in determining the second set of coordinates. Thus, the one or more inputs may enable adjustment of the coefficients when determining the second set of coordinates to adjust a range and precision (e.g., number of bits for an integer portion and number of bits for a fraction) of any suitable number of coefficients.

At block 148, the processor core complex 18 may generate the x-component of the motion vector candidate for the block based on an x-difference between an x-coordinate of the first set of coordinates a u-coordinate of the second set of coordinates. As an example, the processor core complex 18 may employ Equation 3 to generate the x-component. At block 150, the processor core complex 18 may generate a y-component of the motion vector candidate for the block based on a y-difference between a y-coordinate of the first set of coordinates and a v-coordinate of the second set of coordinates. For example, the processor core complex 18 may employ Equation 4 to generate the y-component.

Accordingly, by employing the homography matrix, the electronic device 10 may increase accuracy in generating the motion vector candidate for encoding data (e.g., image data) or for performing additional motion vector estimation. Indeed, employing the homography matrix may enable the electronic device 10 to accurately account for motion (e.g., global motion), translation, and/or changes in perspective between frames of video data. Indeed, the homography matrix may enable the electronic device 10 to accurately map points in one image frame to their corresponding points in another image frame. The electronic device 10 may then generate the motion vector candidate based on the mapped points.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to reduce risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

The invention claimed is:

1. An electronic device comprising:
motion vector estimation circuitry configured to:
receive image data comprising a first image frame and a second image frame;
generate a matrix based on a transformation from the first image frame and the second image frame;
transform a first coordinate space of the first image frame to generate a second coordinate space based on the matrix; and
generate a motion vector candidate based on the first coordinate space and the second coordinate space; and
mode decision circuitry configured to select the motion vector candidate to encode the image data.

2. The electronic device of claim 1, wherein the matrix comprises a homography matrix.

3. The electronic device of claim 1, wherein the motion vector estimation circuitry is configured to generate the motion vector candidate on a per-block basis of the first image frame.

4. The electronic device of claim 1, wherein the motion vector estimation circuitry is configured to generate the motion vector candidate based on a difference between the first coordinate space and the second coordinate space.

5. The electronic device of claim 1, wherein the motion vector estimation circuitry is configured to generate a first component and a second component of the motion vector candidate based on the first coordinate space and the second coordinate space.

6. The electronic device of claim 1, wherein the motion vector estimation circuitry is configured to:
receive a set of block index values; and
determine the first coordinate space based on the set of block index values.

7. The electronic device of claim 1, comprising a motion sensor configured to detect motion, orientation, or both of the electronic device, wherein the motion vector estimation circuitry is configured to generate the matrix based on the motion, the orientation, or both.

8. The electronic device of claim 7, wherein the motion sensor comprises an inertial measurement unit.

9. The electronic device of claim 1, wherein a first set of entries of the matrix are associated with a first precision value, and wherein a second set of entries of the matrix are associated with a second precision value lower than the first precision value.

10. The electronic device of claim 9, wherein the first set of entries are associated with rotation, scaling, a perspective change, or any combination thereof, and wherein the second set of entries are associated with translation.

11. The electronic device of claim 1, comprising an image sensor to capture the image data.

12. A method comprising:
receiving, via processing circuitry, a set of block index values of a block in a first coordinate space of a first image frame;
determining, via the processing circuitry, a first set of coordinates in the block in the first coordinate space based on the set of block index values;
determining, via the processing circuitry, a second set of coordinates in a second coordinate space of a second image frame based on the first set of coordinates and a matrix; and
generating, via the processing circuitry, a motion vector candidate based on the first set of coordinates and the second set of coordinates.

13. The method of claim 12, comprising generating, via the processing circuitry, the motion vector candidate based on a difference between the first set of coordinates and the second set of coordinates.

14. The method of claim 12, comprising generating, via the processing circuitry, a first component and a second component of the motion vector candidate based on the first set of coordinates and the second set of coordinates.

15. The method of claim 12, wherein the matrix comprises a homography matrix.

16. The method of claim 12, wherein a first set of entries of the matrix are associated with a first precision value.

17. The method of claim 16, wherein a second set of entries of the matrix are associated with a second precision value lower than the first precision value.

18. One or more tangible, non-transitory computer-readable media storing instructions that, when executed by processing circuitry, are configured to cause the processing circuitry to:
receive one or more inputs, a first image frame, and a second image frame;
generate a matrix based on the first image frame and the second image frame;
determine a first set of coordinates based on the one or more inputs;
determine a second set of coordinates based on the one or more inputs and the matrix; and
generate a motion vector candidate based on the first set of coordinates and the second set of coordinates.

19. The one or more tangible, non-transitory computer-readable media of claim 18, wherein the instructions, when executed by the processing circuitry, cause the processing circuitry to determine the first set of coordinates based on a shift of a first set of values of the one or more inputs.

20. The one or more tangible, non-transitory computer-readable media of claim 18, wherein the motion vector candidate comprises a first component associated with a horizontal direction and a second component associated with a vertical direction.
